(19) United States
(12) Patent Application Publication
(10) Pub. No.: US 2013/0040799 A1
(43) Pub. Date: Feb. 14, 2013

(54) PROCESS FOR PREPARING HIGH-PURITY MAGNESIUM HYDROXIDE AND MAGNESIUM OXIDE

(71) Applicants: Marcus Georg Schrems, Ludwigshafen (DE); Anna Katharina Dürr, Ludwigshafen (DE); Günther Huber, Ludwigshafen (DE); Jesus Enrique Zerpa Unda, Stuttgart (DE); Katrin Freitag, Ludwigshafen (DE); Michael Karcher, Schwetzingen (DE); Axel Salden, Stuttgart (DE)

(72) Inventors: Marcus Georg Schrems, Ludwigshafen (DE); Anna Katharina Dürr, Ludwigshafen (DE); Günther Huber, Ludwigshafen (DE); Jesus Enrique Zerpa Unda, Stuttgart (DE); Katrin Freitag, Ludwigshafen (DE); Michael Karcher, Schwetzingen (DE); Axel Salden, Stuttgart (DE)

(73) Assignee: BASF SE, Ludwigshafen (DE)

(21) Appl. No.: 13/413,259

(22) Filed: Mar. 6, 2012

Related U.S. Application Data
(60) Provisional application No. 61/515,986, filed on Aug. 8, 2011.

(51) Int. Cl. C01F 5/14; C04B 35/04; C01F 5/22

(52) U.S. Cl. 501/1; 423/636

(57) ABSTRACT

A process for preparing magnesium compounds by precipitation, in which an aqueous solution or suspension of a magnesium compound is mixed with a precipitant and the corresponding magnesium compound is precipitated wherein the aqueous solution or suspension of a magnesium compound is obtained by reaction of an organomagnesium compound with an aldehyde or a ketone or another electrophile and subsequent aqueous workup of the reaction mixture at a pH of at most 10 or from a magnesium salt with a maximum calcium content and/or potassium content of 200 ppm, based on the magnesium salt used.

### CROSS-REFERENCE TO RELATED APPLICATIONS

This application claims benefit (under 35 USC 119(e)) of U.S. Provisional Application 61/515,986, filed Aug. 8, 2011, which is incorporated by reference.

### BACKGROUND OF THE INVENTION

The present invention relates to a process for preparing high-purity magnesium compounds, preferably high-purity magnesium hydroxide and high-purity magnesium oxide, and to the use of the magnesium compound thus obtained, preferably of the magnesium hydroxide or magnesium oxide thus obtained, each as defined in the claims.

Magnesium hydroxide Mg(OH)₂ and magnesium oxide MgO per se are known.

Magnesium hydroxide Mg(OH)₂ and magnesium oxide MgO with a very high purity (MgO content, for example, approx. 99% by weight) are, for example, important additives for the production of ion-conducting ceramics, and additionally also find use in other fields, for example in the production of crucibles for the production of ion-conducting ceramics, for heating cartridges, coil heaters, heating cables, fireproof cables, insulated thermocouples, or generally in electrical engineering for heating purposes or temperature measurement technology, as an additive in animal nutrition, in the production of catalysts, in papermaking, as an additive to rubber and polymers.

Ion-conducting ceramics are described, for example, in J. L. Sudworth and A. R. Tilley, The Sodium Sulphur Battery, Chapman and Hall, New York (1985) and are used inter alia as an electrolyte in electrochemical cells, for example as electrical batteries or synthesis cells for alkali metals. In simplified terms, ion-conducting ceramics are generally produced as follows: alumina, an alkali metal source, generally alkali metal salts, and further additives are shaped (green bodies) and sintered at very high temperature.

Especially for use as an additive for the production of ion-conducting ceramics, it is advantageous when the content of particular alkali metals, alkaline earth metals and transition metals, for example of strontium, barium, beryllium, calcium, potassium, cesium, in the corresponding magnesium hydroxide or magnesium oxide, especially calcium and/or potassium, is not greater than 50 ppm in each case. Preference is given to even lower contents. It is also advantageous to minimize the halide concentration, preferably chloride concentration, in the corresponding magnesium hydroxide or magnesium oxide.

Such relatively pure magnesium hydroxide or magnesium oxide products are commercially available, but are generally so expensive that the cost thereof is a barrier to industrial use.

J. H. Canterford, Mineral Processing and Extractive Metallurgy Review, 1985, 2 (1-2), 57-102, Gordon and Breach Science Publishers, Ltd., describes the precipitation of magnesium hydroxide from seawater with a base and the calcination of the magnesium hydroxide to magnesium oxide. This reference does not disclose, inter alia, organomagnesium compounds.

### A SUMMARY OF THE INVENTION

It was an object of the present invention to remedy the disadvantages of the prior art and to inexpensively provide magnesium hydroxide or magnesium oxide which is especially suitable for use as an additive in the production of ion-conducting ceramics.

The object was achieved by the process defined in the claims and the use defined in the claims.

An aqueous solution or suspension of a magnesium compound suitable for the process according to the invention is obtained in step (1) (i) by reaction of an organomagnesium compound with an aldehyde or a ketone or another electrophile and subsequent aqueous workup of the reaction mixture at a pH of at most 10 or (ii) from a magnesium salt with a maximum calcium content and/or potassium content of 100 ppm, based on the magnesium salt used.

According to variant (i), the aqueous solution or suspension of a magnesium compound is obtained in step (1) of the process according to the invention by reaction of an organomagnesium compound.

To prepare the organomagnesium compound, it is possible, for example, to convert commercially available magnesium by reaction with organic compounds to a form which allows the solution or suspension of the resulting organomagnesium compound, such as RMgX or R₂Mg, in an organic solvent.

This can be accomplished, for example, by reaction of magnesium with an alkyl halide, aryl halide, vinyl halide, aralkyl halide or alkaryl halide, or another organic halide (also known as “Grignard reaction”), generally to form organomagnesium halides (RMgX) or diorganomagnesium compounds R₂Mg. Preferred organic compounds here are organic chlorides, such as alkyl chlorides, aryl chlorides, aralkyl chlorides, alkaryl chlorides, for example C₁-C₁₀-alkyl chlorides such as methyl, ethyl, propyl, butyl, pentyl, hexyl, heptyl, octyl, nonyl or decyl chloride, benzyl chloride, chlorobenzene, vinyl chloride or the like. The Grignard reaction preferably takes place in aprotic ethereal solvents such as diethyl ether, methyl tert-butyl ether, tetrahydrofuran or 2-methyltetrahydrofuran, but can also be performed in other suitable solvents known to those skilled in the art.

The reaction with a further compound and subsequent workup can release the magnesium organically bound beforehand as a salt. For this purpose, for example, the organomagnesium compound RMgX or R₂Mg can be reacted with an aldehyde or a ketone or another electrophile, which generally leads to cleavage of the magnesium-carbon bond in the R-Mg moiety of the organomagnesium compound. Preference is given to aldehydes and ketones.

Subsequently, the reaction mixture is worked up, generally under aqueous conditions, and the aqueous phase is separated from the organic phase by customary processes. Aqueous workup in relation to this reaction mixture is known to those skilled in the art and means typically that the reaction mixture is admixed with water and/or an aqueous protic acid, for example inorganic acids such as hydrochloric acid, sulfuric acid, nitric acid, or organic acids such as acetic acid, and the organic and aqueous phases typically separate.

The aqueous workup takes place at a pH of at most 10, preferably at most 9.5. Examples of pH values for the workup are 0.1, 1, 2, 3, 4, 5, 6, 7, 8, 9, 9.5, 10.

As well as residues of organic components, for example solvent, the aqueous phase comprises magnesium salts, generally mixed magnesium salts, for example Mg(OH)₂, Mg(Cl)₂ or Mg(OH)CI. The water content of the aqueous phase is typically above 50% by weight, preferably above 80% by weight, based in each case on the aqueous phase, including dissolved and/or suspended constituents.

The aqueous phase can optionally be freed of organic solvent residues by heating or stripping. Another source of good suitability for such aqueous phases on the industrial scale is the magnesium-containing aqueous phase (wastewater) obtained in the workup of Grignard reactions, for example from industrial synthesis processes in which organic electrophiles are reacted with Grignard compounds and then worked up under aqueous conditions as described above to isolate the organic target molecule.

According to variant (ii), the aqueous solution or suspension of a magnesium compound is obtained in step (1) of the process according to the invention from a magnesium salt.

Possible magnesium salts include: salts of magnesium with inorganic or organic acids, for example magnesium chloride, magnesium sulfate, magnesium carbonate, magnesium hydrogencarbonate, in each case with or without water of crystallization, preference being given to magnesium chloride with or without water of crystallization (also referred to hereinafter as MgCl₂).

The magnesium salts mentioned in the above paragraph advantageously each have a calcium content and/or potassium content of in each case (based on calcium content or potassium content) at most 200 ppm, preferably at most 100 ppm, more preferably at most 50 ppm, based in each case on the magnesium salt used for step 1 of the process according to the invention. The calcium content or potassium content is understood here as ppm by weight. The calcium content and potassium content are both determined by the known method of ICP-OES (Ion Coupled Plasma-Optical Emission Spectroscopy). This involves dissolving the sample to be analyzed and introducing it into the spectrometer, and measuring the emission thereof against a quantitative standard.

In step (1) of the process according to the invention, the aqueous solution or suspension of a magnesium compound described above under variant (i) is mixed with a precipitant.

The mixing can be accomplished by the processes known to those skilled in the art, without or preferably with stirring, for example in an open stirred vessel.

During or after the mixing, the sparingly soluble magnesium compound corresponding to the precipitant is precipitated, for example magnesium hydroxide in the case of use of an aqueous base (also referred to herein as Mg(OH)₂).

The precipitation takes place typically at temperatures in the range from 10 to 100° C. and at an ambient pressure of 1 atm(abs.), though it is also possible to employ elevated pressure.

Suitable precipitants are base, oxine, inorganic phosphate and inorganic salt of carbonic acid, or any mixtures thereof. Preferred precipitants are bases.

The bases used are advantageously sodium hydroxide or ammonium hydroxide (aqueous ammonia solution) when the inventive magnesium hydroxide or the magnesium oxide obtainable therefrom is to be used for the production of ion-conducting ceramics, especially sodium ion-conducting ceramics.

For other applications, the reaction can, however, also be performed with other hydroxides, such as potassium hydroxide solution.

Bases of good suitability are aqueous dilute bases or mixtures thereof, the water content of which is in the range from 30 to 99% by weight, for example sodium hydroxide solution, potassium hydroxide solution, ammonium hydroxide solution, preferably sodium hydroxide solution or ammonium hydroxide solution.

The base used may also be ammonia as a gas, from which, for example, an aqueous solution of ammonium hydroxide forms on introduction into the aqueous solution or suspension of a magnesium compound in step (1).

Another suitable precipitant is oxine (8-hydroxyquinoline), which precipitates the magnesium as magnesium oxinate.

Other suitable precipitants are inorganic phosphates such as water-soluble alkali metal phosphates, water-soluble alkali metal hydrogenphosphates, water-soluble alkali metal dihydrogenphosphates, preferably disodium hydrogenphosphate and/or ammonium dihydrogenphosphate, diammonium hydrogenphosphate. In a process of good suitability for precipitation of magnesium ammonium phosphate, the aqueous solution or suspension of a magnesium compound, in step (1) of the process according to the invention, is buffered to pH 8 to 9 with ammonia and ammonium chloride and then admixed with aqueous disodium hydrogenphosphate solution, as a result of which the magnesium ammoniumphosphate is obtained as a white acid-soluble precipitate.

The magnesium can also be precipitated as the carbonate from the aqueous solution or suspension of a magnesium compound in step (1) of the process according to the invention by addition of inorganic salts of carbonic acid, preferably alkali metal carbonates, for example disodium carbonate (Na₂CO₃).

Step (2) of the process according to the invention is optional. If it is performed, which is preferred, the mixture from step (1) of the process according to the invention is admixed with a flocculating aid, the method of addition, flocculant to the mixture or mixture to the flocculant or other variants, being uncritical. The admixing can be accomplished, for example, in the stirred vessel from step (1), or during transfer to a second vessel.

Flocculating aids are known in principle. They are usually high molecular weight organic substances such as polymers or polyelectrolytes.

The inventive flocculating aid is, for example, an anionic or cationic or uncharged (synonym: nonionic) organic high molecular weight flocculating aid, or a combination thereof.

Examples of inventive anionic flocculating aids are polyacrylic salts of the alkali metals—such as poly(sodium acrylate)—and polyacrylamide substituted by carboxyl groups.

Examples of uncharged (synonym: nonionic) inventive flocculating aids are polyacrylamide, poly(ethylene oxide) or polymers of 1-vinyl-2-pyrrolidone, N-vinylformamide.

Inventive flocculating aids are described, for example, in the brochure “Sedipur® types for water treatment” from TENSID CHEMIE/BASF Group of August 2002. Examples of such flocculating aids are polyacrylamide (nonionic), polyacrylamide substituted by carboxyl groups (anionic), polyacrylamide substituted by COR groups (R=O—CH₂-CH₂-N(CH₃)₃Cl) (cationic), polyethyleneimine (PEI), poly-DADMAC, polyamines (see page 7 of the brochure mentioned).

Preferred inventive flocculating aids are nonionic or anionic flocculating aids, for example polyacrylamide (nonionic), polyacrylamide substituted by carboxyl groups (anionic), polyacrylic salts of the alkali metals (anionic), particular preference being given to nonionic flocculating aids, for example polyacrylamide.

The amount of the flocculating aid based on the mass of magnesium present in the mixture from step (1) is variable, though it should not be less than 1 mg of pure precipitant per g of magnesium, and more than 10 mg of pure precipitant per g of magnesium generally does not bring any further improvement in effect.

Addition of aqueous bases such as NaOH or aqueous NH₃ solution or NH₃ gas can raise the pH of the aqueous phase, such that magnesium hydroxide precipitates out. This can be removed from the mother liquor by processes known to those skilled in the art and processed further in the form present.

The magnesium hydroxide can alternatively also be washed with water in order, for example, to lower the content of unwanted ions. For example, the chloride content of the magnesium hydroxide can be lowered by washing with water.

The removal of the magnesium hydroxide (Mg(OH)₂) precipitated from the alkaline aqueous medium, for example by sedimentation, can be accelerated when a flocculant is added to the aqueous medium in which the magnesium hydroxide is present.

In step (3) of the process according to the invention, in the mixture of step (1) and optionally of step (2), the solids are removed from the liquid. This can be accomplished by customary processes known to those skilled in the art, such as filtration, sedimentation, centrifugation or the like, preferably sedimentation. For example, the mixture from step (1) and optionally step (2) is transferred into a vessel, for example pumped and left to stand, in the course of which sedimentation takes place (sedimentation 1), in which the solids separate from the liquid. This vessel is, for example, a gravitational separator, for example a settling tank.

The liquid removed (wastewater 1) can be fully or partly reused as an extractant, or else discarded. In a preferred embodiment, the liquid is partly recycled or discarded; in a particularly preferred embodiment, the liquid is discarded.

Step (4) of the process according to the invention is optional. If it is performed, which is preferred, the solids removed in step (3) are mixed with water, preferably while stirring. This can be accomplished, for example, in an open stirred vessel.

The resulting mixture can then be admixed with an inventive flocculating aid, the method of addition, flocculant to the mixture or mixture to the flocculant or other variants, being uncritical. The admixing can be accomplished, for example, in the stirred vessel mentioned, or during transfer to a second vessel. The inventive flocculating aids used are those described above, including the groups or individuals specified as preferred or particularly preferred. It is preferable that the resulting mixture is admixed with an inventive flocculating aid as described above.

Step (5) of the process according to the invention is optional. If it is employed, in the mixture of step (4), the solids are separated from the liquid, as described above under step (3).

The liquid removed (wastewater 2) can be reused fully or partly in step 1 instead of the water, or else discarded. In a preferred embodiment, the liquid is partly recycled or discarded; in a particularly preferred embodiment, the liquid is partly recycled.

Step (6) of the process according to the invention is optional. If it is employed, steps (4) and (5) of the process according to the invention are repeated once or more than once. In a preferred embodiment, steps (4) and (5) are each performed once and not repeated, and so step (6) is not employed.

Steps (1) to (6) of the process according to the invention are generally performed within a temperature range from 10° C. to 100° C. These steps are preferably performed within a temperature range from 15° C. to 50° C.; most preferably, these steps are performed within a temperature range from 15° C. to 30° C. In an alternative embodiment, step three can also be performed within the temperature range from 30° C. up to the boiling point of the mixture. Steps one, two, three and four can be performed within a pressure range from 100 mbar to 10 000 mbar. Performance is preferably effected at atmospheric pressure.

In step (7) of the process according to the invention, the removed magnesium compound obtained by the above-specified steps, preferably the magnesium hydroxide (Mg(OH)₂), for example together with the residues of water present therein, can be dried by the customary methods for drying inorganic suspensions or pastes, for example spray drying, fluidized bed drying. When the drying in step (7) is not performed, the magnesium compound removed after the last process step, preferably the magnesium hydroxide (Mg(OH)₂), still comprises residues of water.

This water-containing magnesium compound, or the magnesium compound obtained after step (7) of the process according to the invention, in each case preferably the magnesium hydroxide (Mg(OH)₂), can be used for preparation of magnesium oxide by thermal treatment of the magnesium compound, preferably of the magnesium hydroxide (Mg(OH)₂), in the range from 600 to 3000° C. and/or for production of sintered shaped bodies, as described by way of example hereinafter, a little further down.

When the magnesium compound obtainable by the present process, preferably the magnesium hydroxide (Mg(OH)₂), is subjected, for example, to a thermal treatment in the range from 600 to 1000° C., preferably at approx. 900° C., the result is typically a calcined magnesium oxide which hardens with water and which can be used, for example, for production of ion-conducting ceramics.

When the magnesium compound obtainable by the present process, preferably the magnesium hydroxide (Mg(OH)₂), is subjected, for example, to a thermal treatment in the range from 1200 to 2800° C., the result is typically a magnesium oxide which no longer hardens with water. This is also referred to in the specialist field as “sintered magnesia”. This sintered magnesia, preferably that which is obtainable at a temperature of approx. 1200 to approx. 1500° C., is used, for example, for production of refractory materials, for example magnesium oxide crucibles. Such magnesium oxide crucibles can be used in turn for production of ion-conducting ceramics, by sintering the green bodies of the ion-conducting ceramic in the magnesium oxide crucibles, for example as described below.

When the magnesium compound obtainable by the present process, preferably the magnesium hydroxide (Mg(OH)₂), is subjected, for example, to a thermal treatment in the range from 2800 to 3000° C., for example in a light arc furnace, the result is typically a magnesium oxide which does not harden with water. This is also referred to in the specialist field as “fused magnesia”. This material generally has the highest hardness.

Useful sintered shaped bodies, which are also referred to as “ceramics”, in principle include all bodies with regular or irregular shape, for example cylinders open at either end, such as tubes; cylinders closed at one end, for example what are called crucibles; disks, angular plaques, rods and tubes with hole patterns.

For example, the sintered shaped bodies, preferably cylinders closed at one end, disks or angular plaques, are ion-conducting ceramics, preferably alkali metal ion-conducting ceramics. Ion-conducting ceramics are described, for example, in J. L. Sudworth and A. R. Tilley, The Sodium Sulphur Battery, Chapman and Hall, New York (1985). They are used, for example, in electrochemical processes, such as electrolysis cells or electrical batteries.

In a first embodiment, the water-containing magnesium compound or the magnesium compound obtained after step (7) of the process according to the invention, preferably in each case the magnesium hydroxide (Mg(OH)₂), is treated thermally within the temperature range from 600 to 3000° C., for example 600 to 1000° C., 1200 to 2800° C., 2800 to 3000° C., generally in an oxygenous atmosphere, preferably air. The thermal treatment, also referred to in the specialist field as “calcining”, takes place typically in the apparatuses known to those skilled in the art, such as rotary tube furnaces, muffle furnaces, light arc furnaces (the latter particularly for the temperatures in the range from 2800 to 3000° C.). This thermal treatment converts the magnesium compound obtained by the process according to the invention to magnesium oxide (MgO), also called magnesia, specifically, as described above, to calcined magnesium oxide which hardens with water, sintered magnesia or fused magnesia. The inventive magnesium oxide can then be used further for production of the above-described sintered shaped bodies, including the preferred or particularly preferred embodiments thereof. For example, the inventive magnesium oxide, preferably that which is obtainable at a temperature of approx. 1200 to approx. 1500° C., can be used for production of sintered shaped bodies, preferably cylinders closed at one end, called “crucibles”. These crucibles may also be of modular structure; for example, they comprise a cylinder closed at one end as a base, on the open side of which a cylinder open at both ends or several cylinders open at both ends may be placed and bonded, and these crucibles may be covered with a lid of any geometry. The inventive sintered shaped bodies, preferably the crucibles described herein, can be used, for example, for production of ion-conducting ceramics, for example by placing the precursor shaped body (green body) of the ion-conducting ceramic in the crucible of inventive magnesium oxide described here, and subjecting it to a thermal treatment.

In one variant of the first embodiment, the magnesium compound in step (1) of the process according to the invention is precipitated with an aqueous ammonia solution and then treated thermally within the temperature range from 600 to 3000° C., for example 600 to 1000° C., 1200 to 2800° C., 2800 to 3000° C., generally in an oxygenous atmosphere, preferably air. This thermal treatment converts the magnesium compound obtained by the process according to the invention to magnesium oxide (MgO) which features particularly low chloride contents. The magnesium oxide can then be used further for production of the above-described sintered shaped bodies, including the preferred or particularly preferred embodiments thereof.

In a second embodiment, the water-containing magnesium compound obtained by the process according to the invention or the magnesium compound dried in step 7, preferably the magnesium hydroxide (Mg(OH)₂), can also be mixed with further additives, for example aluminum oxide (Al₂O₃) and/or sodium salts and binders, and be ground, for example, in aqueous suspension and then dried, preferably spray-dried. This modified magnesium compound, preferably magnesium hydroxide (Mg(OH)₂), can then be used further for production of the above-described sintered shaped bodies, including the preferred or particularly preferred embodiments thereof, for example ion-conducting ceramics, preferably alkali metal ion-conducting ceramics, or the crucibles described herein.

### Examples

### Example 0

The wastewater (pH=9.3) obtained from the industrial scale reaction of a Grignard reagent (RMgX) with an electrophile and subsequent acidic aqueous workup of the reaction mixture was concentrated by evaporation and the residue was analyzed. The calcium content was <10 ppm. A typical composition of further components was: Mg approx. 19 g/100 g and approx. 35 g/100 g of chlorine as chloride.

### Example 1

The wastewater according to example 0 was adjusted to pH=10.4 with 25% aqueous ammonia solution and stirred at room temperature for one hour. Thereafter, the mixture of solids and liquid was filtered through a membrane suction filter for approx. 5 hours. Thereafter, the solids were mixed with 100 ml of water and heated to approx. 100° C. (15 min). Thereafter, the mixture was cooled and filtered through a membrane suction filter. The washing with water was repeated twice more. Subsequently, the residue of magnesium hydroxide was dried (120° C., 10 mbar) and analyzed: magnesium content 41 g/100 g of substance; chlorine content 1000 ppm. The example shows inter alia that the filtration proceeds slowly.

### Example 2

The material obtained from example 1 was heated in a muffle furnace in air atmosphere at 1000° C. for one hour. Analysis of the resulting magnesium oxide gave: approx. 59 g of Mg/100 g; 10 ppm of Cl. This example shows that calcining of the Mg(OH)₂ precipitated with aqueous ammonia solution at 1000° C. converts the Mg(OH)₂ to MgO and can lower the chlorine content to very low values.

### Example 3

The wastewater according to example 0 was adjusted to pH=11.5 with 25% aqueous NaOH solution (sodium hydroxide solution) and stirred at room temperature for one hour. Thereafter, the mixture of solids and liquid was filtered through a membrane suction filter. A portion of the crude magnesium hydroxide solids was dried and analyzed: magnesium content: 32 g/100 g; chlorine content: 13.1 g/100 g. Thereafter, the remaining crude magnesium hydroxide solids were washed four times with 50 ml each time of water. Subsequently, the residue was dried (120° C., 10 mbar) and analyzed: magnesium content 40 g/100 g of substance; chlorine content 1000 ppm.

### Example 4

The wastewater according to example 0 was adjusted to pH=11.5 with 25% aqueous ammonia solution and stirred at room temperature for one hour. Thereafter, the mixture was filtered through a membrane suction filter. A portion of the crude magnesium hydroxide solids was dried and analyzed: magnesium content: 39 g/100 g; chorine content: 2.5 g/100 g. Thereafter, the remaining crude magnesium hydroxide solids were washed four times with 50 ml each time of water. Subsequently, the residue was dried (120° C., 10 mbar) and analyzed: magnesium content 41 g/100 g of substance; chlorine content 1400 ppm.

Examples 3 and 4 show that the magnesium hydroxide can be obtained by addition of sodium hydroxide solution or ammonia solution. The washing can also be effected at room temperature and lowers the chlorine content.

### Example 5

The wastewater according to example 0 (1 kg) was admixed (pH=10.3) with 25% aqueous ammonia solution (224 g) and stirred at room temperature for 30 min. The product does not sediment after the stirrer has been switched off. Subsequently, 50 g of a 0.1% by weight aqueous Sedipur® NF106 (nonionic polyacrylamide of moderate to high molar mass) solution were added. The mixture was stirred for 7 min. After approx. 30 seconds, the precipitated Mg(OH)₂ settled out completely. The magnesium content of the supernatant was <1000 ppm. The Mg(OH)₂ thus obtained could be separated from the supernatant by filtration without any problem.

### Example 6

The wastewater according to example 0 (100 g) was admixed with 20 g of a 25% ammonia solution.

Addition of various flocculant types, as described hereinafter, precipitated the Mg(OH)₂ formed.

In the case of use of a 0.1% aqueous solution of the nonionic flocculant Sedipur®NF 104 (moderate to high molar mass), 1.7 ml of Sedipur solution were required to obtain good, visible flocculation; on addition of a total of 5 ml of this solution, rapid precipitation with formation of large flakes was evident.

In the case of use of a 0.1% aqueous solution of the nonionic flocculant Sedipur®NF 106 (moderate to high molar mass), 1.7 ml of Sedipur solution were required to obtain good, visible flocculation; on addition of a total of 4 ml of this solution, rapid precipitation with formation of large flakes was evident.

In the case of use of a 0.1% aqueous solution of the anionic flocculant Sedipur® AF 900, approx. 10 ml of Sedipur solution were required to obtain visible flocculation and relatively slow precipitation.

In the case of use of a 0.1% aqueous solution of the cationic flocculant Sedipur CF 803, no visible flocculation was evident after addition of >15 ml of Sedipur solution.

This example shows that nonionic and anionic flocculants are suitable for the separation of the Mg(OH)₂ obtained from the mother liquor. Particularly suitable flocculants are nonionic flocculants of moderate to high molar mass, which is evident inter alia from the fact that smaller amounts thereof have to be added to achieve rapid precipitation.

### Example 7

The wastewater according to example 0 (300 g) was admixed (pH=11.65) with 25% aqueous sodium hydroxide solution (29 g) and stirred at room temperature for 60 min. The product does not sediment after the stirrer has been switched off. 90 ml of this suspension were subsequently admixed with 2 g of a 0.1% (w/w) aqueous Sedipur® NF104 (nonionic polyacrylamide of moderate to high molar mass). The mixture was stirred for 7 min. After approx. 30 seconds, the precipitated Mg(OH)₂ settled out completely. The Mg(OH)₂ thus obtained could be separated by filtration from the supernatant without any problem. The filter cake was dried at 120° C. under reduced pressure (10 mbar) and then calcined at 1200° C. The chloride content before calcination was 2900 ppm; the chloride content after calcination was 30 ppm. The magnesium content of the MgO thus obtained corresponded to the theoretical content of 59 g/100 g.

This example shows that the combined use of NaOH solution (sodium hydroxide solution) and flocculant leads to rapid precipitation as Mg(OH)₂, and the product after calcination has a lower chlorine content of <50 ppm.

1-19. (canceled)

20. A process for preparing magnesium compounds by precipitation, in which
(1) an aqueous solution or suspension of a magnesium compound is mixed with a precipitant selected from the group of base, oxine, inorganic phosphate and inorganic salt of carbonic acid, and the corresponding magnesium compound is precipitated,
(2) the mixture from step (1) is optionally admixed with a flocculating aid,
(3) in the mixture of step (1) and optionally of step (2), the solids are separated from the liquid,
(4) optionally, the solids removed are mixed with water, in the presence or in the absence of a flocculating aid,
(5) optionally, in the mixture of step (4), the solids are separated from the liquid,
(6) optionally, steps (4) and (5) are repeated once or more than once,
(7) and, optionally, the solids removed are dried, optionally after addition of further compounds, wherein the aqueous solution or suspension of a magnesium compound is obtained in step (1) (i) by reacting an organomagnesium compound with an aldehyde or a ketone or another electrophile and subsequent aqueous workup of the reaction mixture at a pH of at most 10 or (ii) from a magnesium salt with a maximum calcium content and/or potassium content of 200 ppm, based on the magnesium salt used.

21. The process according to claim 20, wherein the precipitant in step (1) is a base.

22. The process according to claim 21, wherein the base is a hydroxide and the magnesium compound is magnesium hydroxide.

23. The process according to claim 21, wherein the base is sodium hydroxide or ammonium hydroxide.

24. The process according to claim 20, wherein the separation of the solids from the liquid in steps (3) and/or (5) is accomplished by sedimentation.

25. The process according to claim 20, wherein step (4) is performed obligatorily.

26. The process according to claim 20, wherein step (2) and/or (4) is/are conducted obligatorily and in the presence of a flocculating aid.

27. The process according to claim 26, wherein the flocculating aid is an anionic, cationic, uncharged flocculating aid.

28. The process according to claim 26, wherein the flocculating aid is selected from the group consisting of polyacrylamide (nonionic), polyacrylamide substituted by carboxyl groups (anionic), polyacrylamide substituted by COR groups (R=O—CH2-CH2-N(CH3)3Cl) (cationic), polyethyleneimine (PEI), poly-DADMAC and polyamine.

29. The process according to claim 20, wherein the liquid from step (5) is recycled fully or partly into step (4) as a medium for mixing.

30. A process for preparation of a magnesium oxide compound which comprises thermally treating the magnesium compound obtained by the process defined in claim 20 in the range from 600 to 3000° C.

31. A process for production of sintered shaped bodies which comprises utilizing the magnesium compound obtained by the process defined in claim 20.

32. A process for production of sintered shaped bodies which comprises utilizing the magnesium oxide compound obtained by the process defined in claim 30.

33. The process according to claim 31, wherein the shaped bodies are open cylinders or cylinders closed at one end, discs or angular plaques.

34. The process according to claim 31, wherein the shaped bodies are ion-conducting ceramics.

35. The process according to claim 31, wherein the shaped bodies are alkali metal ion-conducting ceramics.

36. The process according to claim 31, wherein the magnesium compound is used together with other components.

37. The process according to claim 31, wherein the sintered shaped bodies are used for production of ion-conducting ceramics.

38. A process for production of ion-conducting ceramics which comprises utilizing the sintered shaped bodies obtained by the process according to claim 31.
